(19) United States
(12) Patent Application Publication
(10) Pub. No.: US 2022/0318319 A1
(43) Pub. Date: Oct. 6, 2022

(54) Focus Events

(71) Applicant: The Fin Exploration Company, San Francisco, CA (US)

(72) Inventors: Ben Vishny, Winnetka, IL (US); Evan Lloyd, Berkeley, CA (US); Samuel Lessin, San Francisco, CA (US)

(21) Appl. No.: 17/219,588

(22) Filed: Mar. 31, 2021

(51) Int. Cl. G06F 16/951; G06F 16/906; G06F 11/34

(52) U.S. Cl. CPC G06F 16/951; G06F 16/906; G06F 11/3438; G06F 2201/86; G06F 2201/81; G06F 2201/835; G06F 2201/875

(57) ABSTRACT

Methods, systems, and apparatus, including computer programs encoded on computer storage media, for determining focus events. One of the methods includes determining time spent by a user. A sequence of events occurring in multiple software services being accessed by a user is tracked. The sequence of events includes one or more events from each case of a group of cases handled by the user. Using information extracted from one or more interactions of the user with at least one service, focus events are determined that identify which case in the group of cases is being worked on by the user at various points in time, each focus event having a focus event duration. Using the extracted information, each focus event of the focus events is assigned to a particular case. A total period of time spent by the user on the particular case is determined based on a sum of focus events durations for the focus events assigned to the particular case.

### TECHNICAL FIELD

This specification relates to tracking events.

### BACKGROUND

Computer users often multitask, doing multiple things at once. A computer user may be a customer support agent who may split their time across multiple cases, such as to provide support to customers phoning in or using a chat box to obtain support. The customer support representative may spend different portions of time helping each of the customers. The customer support representative may also perform other actions on the computer that are not related to any of the customers' cases.

### SUMMARY

This specification describes technologies for discretizing time spent by users (e.g., customer service agents) doing specific tasks on computers. These technologies generally involve connecting identifiers from different systems while users spend time on the different systems on a specific task. The system can manage more than a hundred or more than a thousand cases at one time or within a specified time period of (e.g., within a minute or within an hour) and the system can also manage more than a hundred or more than a thousand users (e.g., customer service agents) at one time or over a specified time period (e.g., within a minute or within an hour).

In general, one innovative aspect of the subject matter described in this specification can be embodied in methods that include the actions of determining time spent by a user. A sequence of events occurring in multiple software services being accessed by a user is tracked. The sequence of events includes one or more events from each case of a group of cases handled by the user. Using information extracted from one or more interactions of the user with at least one service, focus events are determined that identify which case in the group of cases is being worked on by the user at various points in time, each focus event having a focus event duration. Using the extracted information, each focus event of the focus events is assigned to a particular case. A total period of time spent by the user on the particular case is determined based on a sum of focus events durations for the focus events assigned to the particular case.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular embodiments so as to realize one or more of the following advantages. First, work performed by a customer service agent on different systems and having different identifiers can be correlated without customer service agent needing to explicitly identify what they are working on. The past behavior patterns of customer service agents and the usual steps for completing a case can be used to correlate actions taken by a customer service agent on a new case. This information can be used to determine most efficient agents and agents that need attention, and can be used for routing of types of work and for training.

The details of one or more embodiments of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1A shows an example of a workforce analytics system that can be used to determine discrete time spent by customer service agents on different tasks across different systems and produce reports based on discretized time, according to some implementations of the present disclosure.

FIG. 1B shows an example of a workforce analytics manager (WAM), according to some implementations of the present disclosure.

FIG. 2 is a screenshot of a customer screen for handling cases in the workforce analytics system 100, according to some implementations of the present disclosure.

FIG. 3 is a screen shot of an example of a search analytics page for looking up customer service agent events, according to some implementations of the present disclosure.

FIG. 4 is a screen shot of an example of a dashboard for customer service agent time spent on cases, according to some implementations of the present disclosure.

FIG. 5 is a screen shot of an example of a focus events structure, according to some implementations of the present disclosure.

FIGS. 6A-6B are screen shots collectively showing an example of a true utilization page, according to some implementations of the present disclosure.

FIGS. 7A-7B are screen shots collectively showing an example of a true handle time page, according to some implementations of the present disclosure.

FIGS. 8A-8B are screen shots collectively showing an example of an outliers page, according to some implementations of the present disclosure.

FIG. 9 is a screen shot of an example of a customer service agent summary page, according to some implementations of the present disclosure.

FIG. 10A is a screen shot of an example of a process flow diagram, according to some implementations of the present disclosure.

FIG. 10B is a screen shot of an example of a process timeline, according to some implementations of the present disclosure.

FIG. 11 is a screen shot of an example of a resource analysis page, according to some implementations of the present disclosure.

FIG. 12 is a screen shot of an example of a trigger event definition page, according to some implementations of the present disclosure.

FIG. 13 is a screen shot of an example of a clickstream page, according to some implementations of the present disclosure.

FIG. 14A is a screen shot of an example of a case defining services per organization page, according to some implementations of the present disclosure.

FIG. 14B is a screen shot showing an example of a document object model (DOM) tools page, according to some implementations of the present disclosure.

FIG. 14C is a screen shot showing an example of an add DOM fingerprint page, according to some implementations of the present disclosure.

FIG. 15 is a flowchart of an example of a method for determining time spent by the customer service agent on the particular case, according to some implementations of the present disclosure.

FIG. 16 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for discretizing time spent by users (e.g., customer service agents) doing specific tasks on computers. These technologies generally involve associating identifiers (IDs) from different systems while users spend time handling a case spanning multiple pages and applications of the different systems. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure can be used to assign each user action to a single “case” that a customer service agent is working on when the customer service agent is working simultaneously on more than one case. For example, the customer service agent can be a customer representative agent that handles Customer Relationship Management (CRM) cases that arrive at a CRM system by phone call, chat session, or online portal.

In some implementations, discretizing time can include setting identifier threshold rules, so as to define finer-grain criteria used to identify events that count as being associated with a case. Rules can also be used to define and access a set of identifiers used in set of systems that are to be tracked. Techniques of the present disclosure can be used to disregard time spent associated with identifiers that are not included in a tracked subset of systems to be tracked. Moreover, techniques of the present disclosure can be used to disregard identifiers corresponding to events that last less than a threshold event duration. Doing so can provide the benefit of avoiding an interruption of a current count of work being discretized.

Identifiers from multiple systems can be linked by observing an expected behavioral pattern of a user, such as a customer support agent. As an example, the system can determine that customer support agents generally follow a certain workflow on a given case. The identifiers used in the different systems that are accessed during the workflow can be linked together even if their linkage was previously unknown. For example, a chat application (or app) for chatting with customers may have a chat ID which is used as the case ID of the case. In a new chat, the customer support agent may use their own internal CRM system where they look up the customer. The internal CRM system may have a completely different set of identifiers, different from the chat app. If it is known that the customer support agent is always going to look up the customer in a certain amount of time after getting a new customer chat request, then the identifiers can be automatically associated or linked.

In some implementations, input context intervals (ICIs) can be used to improve the tracking of events in a more efficient way. An ICI is defined as a time interval having beginning and ending timestamps corresponding to a user action having a context (e.g., associated with a specific case). For example, events can be tracked by recording keystrokes. If the customer support agent is working on multiple cases at the same time, techniques of the present disclosure can be used to determine which case gets precedence. If a customer support agent is switching between systems, as noted above techniques of the present disclosure can link two systems that have their own case IDs but that are linked by the workflow. In order to be more efficient in linking cases and tracking time spent by customer support agents on each case, techniques of the present disclosure can be used to only allow one case to interrupt a second case if the duration of the interrupting event is above a threshold time. The threshold time can be a variable by specific situation and the system(s) that are involved. In computer systems that implement the techniques of the present disclosure, computer-implemented methods can be implemented for determining the primary task on which an agent is working when it appears that the agent is working on multiple simultaneous tasks. The computer-implemented methods can use configurable rules.

A browser in which the chat app executes can use an application programming interface (API) to send a data stream to a back end system for interpretation. APIs can be programmed to notice events that occur inside a browser or outside a browser. For example, a browser (e.g., Chrome) plugin can be implemented such that whenever an agent switches windows within a browser and visits a new page, the system records the event (e.g., the event data is sent to the backend system). A similar API can exist in Windows, for example, when an agent switches to a different window, sending event data to a server/backend. For example, the event data can indicate that the agent spent a specified amount of time on website V, or the agent spent a specified amount of time in application window X with page title Y.

In some implementations, ICIs can be implemented through the use of recording timestamps instead of just recording a time duration. In this way, the timestamps can additionally be used to correct durations corresponding to the start and end times spent on a webpage by a customer support agent. As an example, the timestamps can be fitted to key strokes that occur when a customer support agent is on a particular web page.

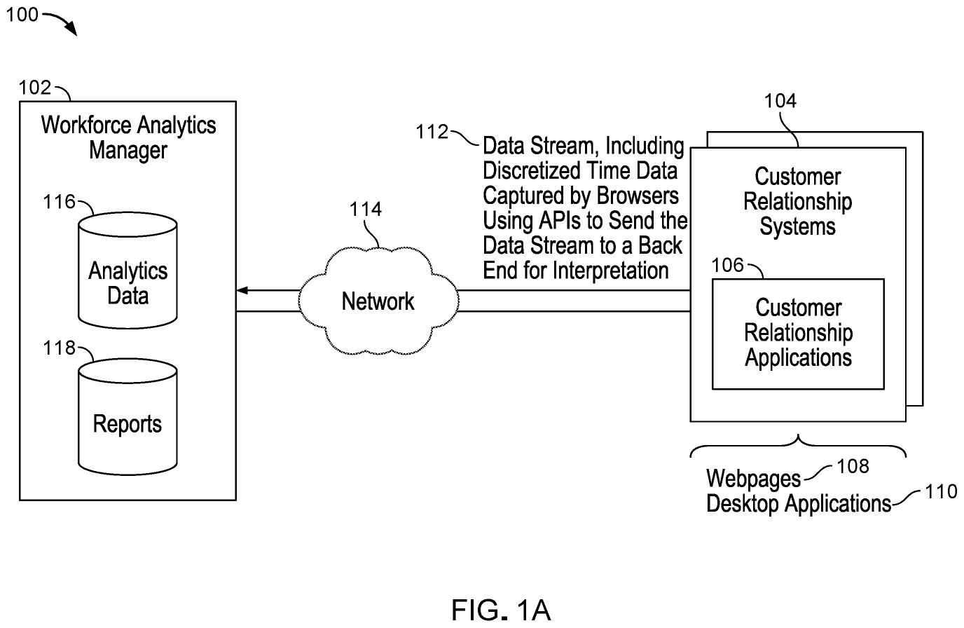

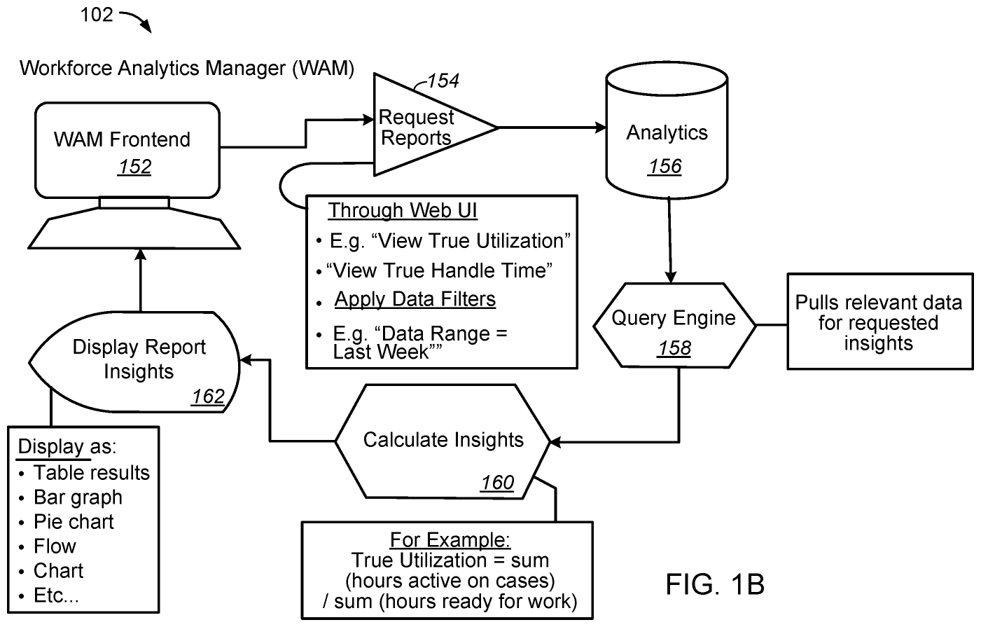

FIG. 1A shows an example of a workforce analytics system 100 that can be used to determine discrete time spent by customer service agents on different tasks across different systems and produce reports based on discretized time, according to some implementations of the present disclosure. The workforce analytics system 100 includes a workforce analytics manager 102 that interfaces with one or more customer relationship systems 104. Each customer relationship system 104 includes one or more customer relationship applications 106, such as CRM systems. Users (such as CRM agents) can use the customer relationship system 104, for example, by accessing webpages 108 and using desktop applications 110.

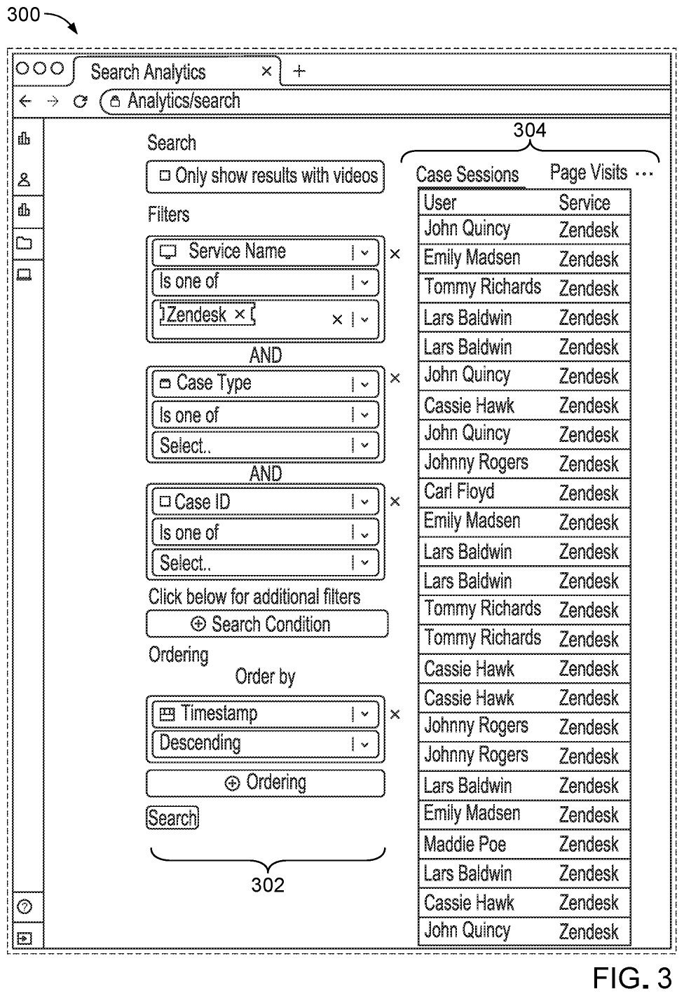

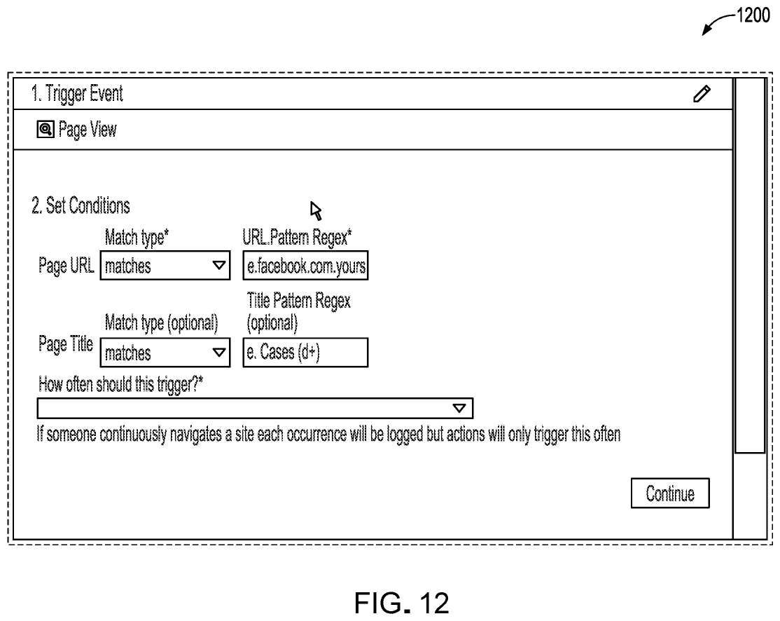

While an agent is using the customer relationship systems 104, a data stream 112 is sent to the workforce analytics manager 102 for interpretation. The data stream 112 can include discretized time data captured by browsers using APIs to send the data stream to a back end for analysis. The workforce analytics manager 102 can store the received data stream 112 as analytics data 116. The workforce analytics manager 102 can use the analytics data 116 to generate reports. The report can include, for example, reports containing information described with reference to FIGS. 3-11. Techniques by which the data stream 112 captures data include parameters and set-up operations described with reference to FIGS. 12-14C. Components of the workforce analytics system 100 are connected using a network 114 that includes, for example, combinations of the Internet, one or more wide area networks (WANs), and one or more local area networks (LANs).

Examples of reports that can be produced using discretized time data can include focus events. Focus events can be used, for example, to assign each action performed by an agent to a single “case.” An action that is assigned to a case can be disambiguated from actions performed on other cases. Discretizing the time and assigning events to specific cases can be based on cross-platform tagging for each active session. Automatic matching can occur, for example, when an agent opens a specific document within a specific period of time after opening a case. The automatic matching can use agent behavior pattern recognition that incorporates logic for timeouts, accesses to specific pages and documents, and automatic linking of identifiers from disparate systems.

The workforce analytics system 100 can perform tracking in the context of multiple workflows and multiple customers. For example, a customer service agent may have a workflow to provide a customer refund that requires the customer service agent to access a number of different systems. Based on a list or pattern of the different systems necessary for a particular type of task, workforce analytics system 100 can insure that the customer service agent follows a proper procedure while collecting metadata from each system that the customer service agent accesses and linking the metadata together.

A customer service agent may be handling multiple, simultaneously customer service cases (for example, chats) at once. Even though the time is overlapping for each of the associated customers, the workforce analytics system 100 can determine how much of their time is actually spent on each customer. The time that is tracked includes not only how much time the customer service agent is chatting with that customer, but how much time the customer service agent is spending working on that customer versus working on actions associated with another customer. The workforce analytics system 100 can use clustering algorithms and other techniques to identify that an agent is working on the same case across different systems. The clustering can occur, for example, using text copied from one box into another and based on patterns of access of different systems when handling a case.

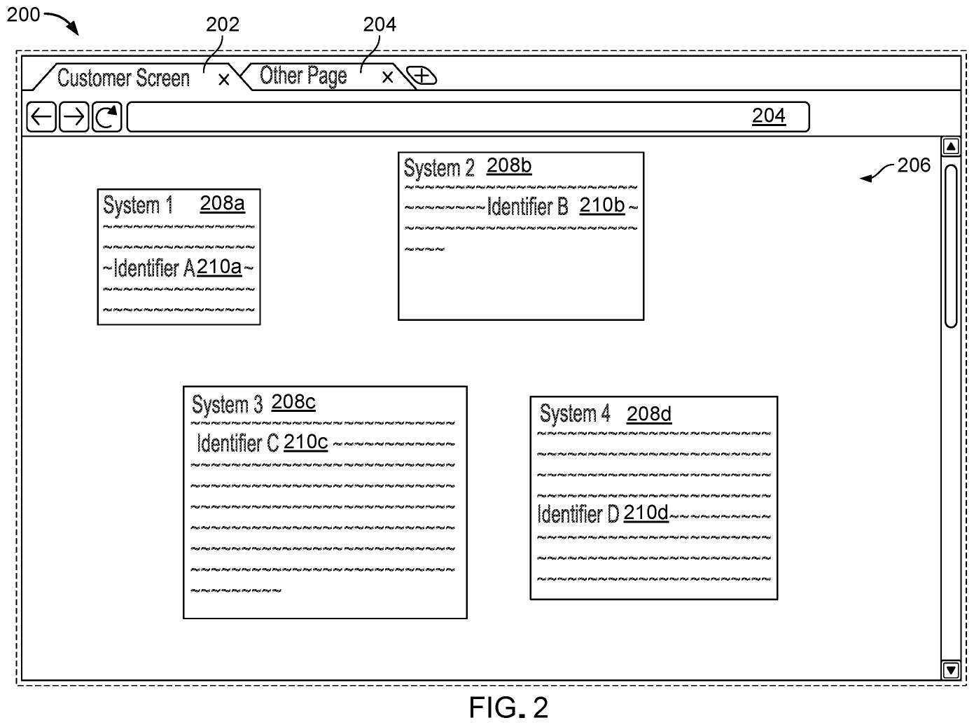

FIG. 1B shows an example of the workforce analytics manager (WAM) 102 of FIG. 1A, according to some implementations of the present disclosure. The WAM 102 includes a WAM front end 152 that provides a user interface for a user to request reports 154, for example, using analytics data 156. The analytics data 156 can include data described with reference to FIGS. 2-9. Report requests 154 can be made by a user through a web user interface (UI). Example reports can include viewing true utilization and viewing true handle time. Using the UI, the user can apply filters, including user filters and date filters (e.g., date range=last week). The analytics data 156, including user actions and event data, can serve as data input to a query engine 158 accessible through the UI for accessing relevant data for requested insights. Calculated insights 160 can be used to display report insights 162. For example, for a report providing true utilization (including user efficiency and time spent on cases), the insights can be used to create a ratio of hours active on cases and hours ready for work. Displayed reports can be displayed, for example, as table results, bar graphs, pie charts, and flow charts. Example reports are described with reference to FIGS. 2-10B.

FIG. 2 is a screenshot 200 of a customer screen 202 for handling cases in the workforce analytics system 100, according to some implementations of the present disclosure. The customer screen 202 can be an interface used by a user (for example, a customer service agent). The customer screen 202 can be one of many screens available and used in the user's browser or on the user's desktop to handle cases, including another page 204 that may present a user interface for specific products or services. An originating call, such as a chat, may originate on the customer screen 202 used by an agent. The agent may immediately or subsequently navigate to other resources, such as other pages 204, to look up the customer or perform some other action related to the case.

Working areas 206 in customer screens 202 and other pages 204 can include several pages 208a-208d (or specific screens), accessible through browsers, for example, each with corresponding identifiers 210a-210d. Other resources accessed by the customer service agent can include documents such as word documents and spreadsheets for presenting and recording information associated with a case. The identifiers 210a-210d may be completely different across the systems associated with the pages 208a-208d. However, the workforce analytics system 100 can use the analytics data 116 to associate an identifier with work done on various uncoordinated systems, which in turn can link together time spent on those different systems for the same case. The various uncoordinated systems can provide multiple software services such as web pages, documents, spreadsheets, workflows, desktop applications, and conversations on communication devices. The multiple software services include at least a software service of a first type and a software service of a second type, where the software service of the first type and the software service of the second type are uncoordinated software services lacking inter-service communication and a common identification labelling system.

In some implementations, the following steps can be used for assigning an event to a case. First, the system determines a location of a case ID or other identifier. For example, the identifier may only be seen on webpages matching specific Uniform Resource Locator (URL) patterns or using specific desktop apps. Such identifiers can be extracted from the URL, from a page/app title, or from a specific region in the HTML hierarchy of the webpage.

Each website or desktop app where an ID can be extracted is known as a service. By associating observed identifiers together with multiple services, events from multiple services can be associated together under a single case ID. The case ID can originate from whichever service the system determines to be the primary service.

To associate a first identifier with a second identifier, a sequence of events can be defined that represents the observation of identifiers in a particular order, within a bounded time-frame. The system can use this defined sequence of events to link events and their respective identifiers. Such a defined sequence can be a sequence of pages, for example, that are always, or nearly always, visited, in order and in a time pattern, when a new case is originated and handled by a customer service agent. Whenever a linked identifier is determined, that event and any subsequent events are associated with the case as identified by the identifier from the primary service.

In a working example, consider a customer service agent that engages in multiple simultaneous chats and uses a separate CRM service to look up customers and make changes to their accounts. Since the customer service agent switches between the chat windows and the CRM service, there is a need to know, specifically, how much time is spent on each customer and case. The following sequence of events can be defined.

First, the customer service agent receives a new chat box, for example, entitled “Chat 123” on a website that is considered as the primary service. The new Chat ID 123 is created, and the Case ID is marked with the Chat ID. Second, within a threshold time period (e.g., 60 seconds), the customer service agent searches the CRM system for the customer.

Third, within another 60 seconds, the customer service agent lands on the customer's page within the CRM that matches the URL pattern (for example, crm.site.com/customers/234). The CRM ID 234 is recognized, and the ID 234 is linked with Case ID 123.

Fourth, the customer service agent responds to another customer and enters a chat box, for example, with Chat ID 567. This action and subsequent actions in this chat box are not associated events with Chat 123, but instead are associated with Chat 567.

Fifth, the customer service agent goes back to the CRM system on page crm.site.com/customers/234. This surfaces CRM 234 which is linked with Chat 123, associating that event and subsequent events with case 123 until the next time case 123 is interrupted.

Note that, if the customer service agent performs other events at the same time as the sequence of events described above, such additional events do not affect the system's ability to recognize system operation. This is because certain implementations do not require that the set of events is exclusively limited to the chat and CRM events noted above.

In some implementations, the functionality of the techniques of the present disclosure can be represented in pseudocode. Assume that event stream is a variable that represents a time-ordered list of the following types of events: 1) webpage visits with URLs and page titles, 2) desktop application window events with page titles, and 3) clicks, events, and interactions within a web page on a particular webpage element or region that has its own descriptors. A case ID can be defined as any identifier associated with a service that is the primary tool used for customer communications. In such a case, pseudocode describing operation of the workforce analytics manager of FIG. 1A can include:

```
identifier_mappings = <Mapping of Case ID to list of linked identifiers>
all_possible_sequences = <List of event sequences already in process for
each rules pertaining to possible sequences of events>
current_case_id = None
for event in event_stream:
  for current_sequence_step in all_possible_sequences:
    if current_sequence_step.matches(event):
      identifiers = current_sequence_step.get_identifiers(
        event.page_title,
        event.url,
        event.html
      )
      current_sequence_step.move_to_next step( )
      current_case_id = current_sequence_step.get_case_id( )
      # If current_case_id cannot be resolved this way look
      # for a mapping
      If not current_case_id:
        current_case_id = [
        key for (key, existing_identifiers) in identifier_mappings
        if identifiers intersects existing_identifiers
        ]
      if current_case_id:
      identifier_mappings[current_case_id].append(identifiers)
  event.case_id = current_case_id (attribute event to Case ID)
```

At a high level, the pseudocode links events (e.g., customer service agent actions) to corresponding cases and captures event information (e.g., clicks, customer service agent inputs) for the events, e.g., by stepping through a sequence of events that have occurred. Once the system has analyzed agent events and assigned those events to various cases, the system can provide a variety of useful functions. For example, FIG. 3 is a screen shot of an example of a search analytics page 300 for looking up customer service agent events, according to some implementations of the present disclosure. The search analytics page 300 includes search controls that facilitate searching for particular types of customer service agent data, for example, for actions and events by one or more specific customer service agents. The filters can be used to select customer service agent events by combinations of customer service agent name, case type, and case ID. Sorting controls can allow a user of the search analytics page 300 to sort the output of filtered information in different ways.

The search analytics page 300 displays data stream information that can be collected to identify how customer service agents are spending their time on particular cases. The information that is displayed can include case type (for example, printer fires) or specific application (for example, ZENDESK).

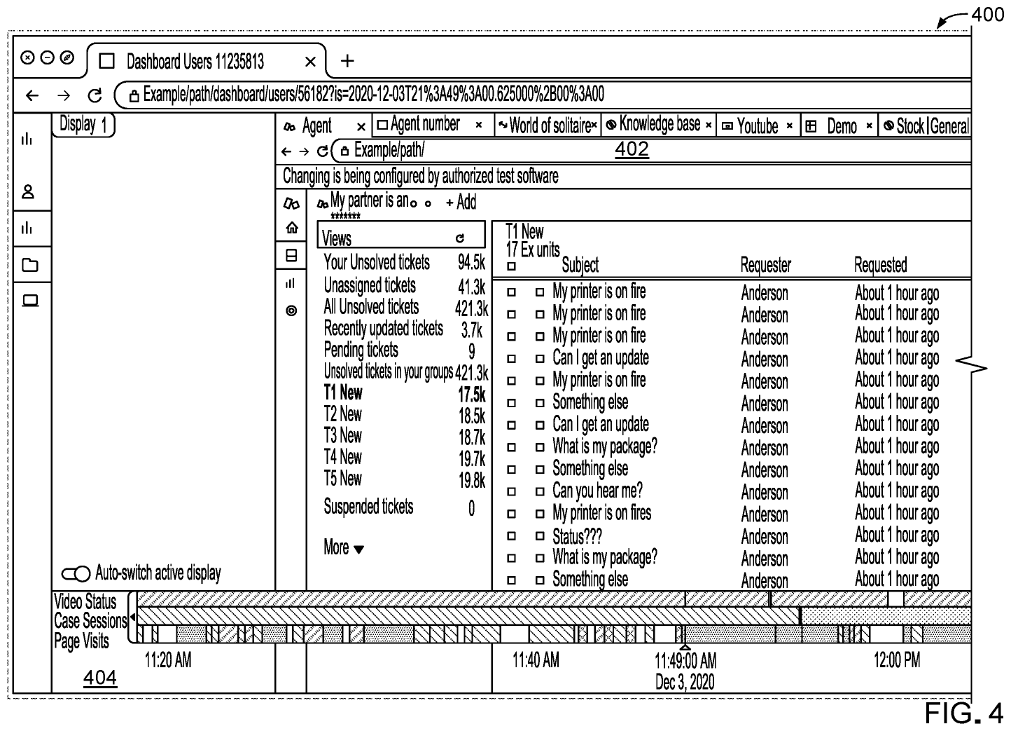

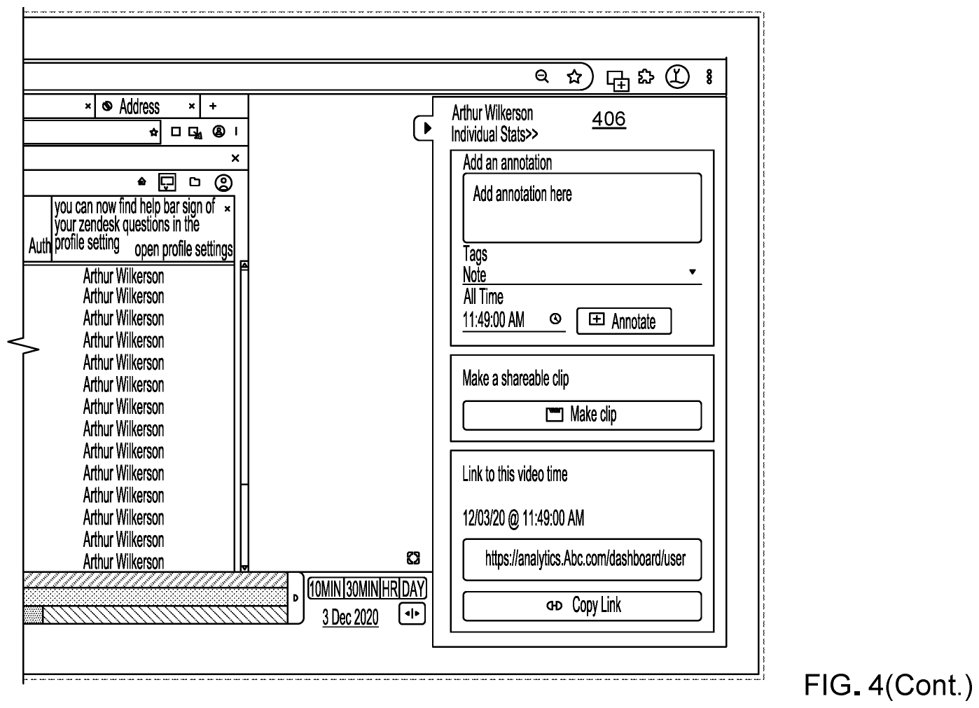

FIG. 4 is a screen shot of an example of a dashboard 400 for customer service agent time spent on cases, according to some implementations of the present disclosure. A cases information area 402 can list different cases, each case's case type (e.g., “My printer is on fire”), and other information for each case.

A video playback area 404 can allow the user of the dashboard 400 to open a video corresponding to focus events for a particular case. The case session video playback area 404 can include a video status bar, a case sessions bar, and a page visits bar. Each bar is displayed relative to time, for example, from opening a case until handling of the case is complete.

A video status bar in the dashboard 400 can allow the user to display a video of what has occurred on overlapping cases. For example, playing the video in high speed can show the overlapping case sessions on which a customer service agent has worked. The video can show, for example, that the customer service agent was working on case X, then looking at a different case, then working on case X again.

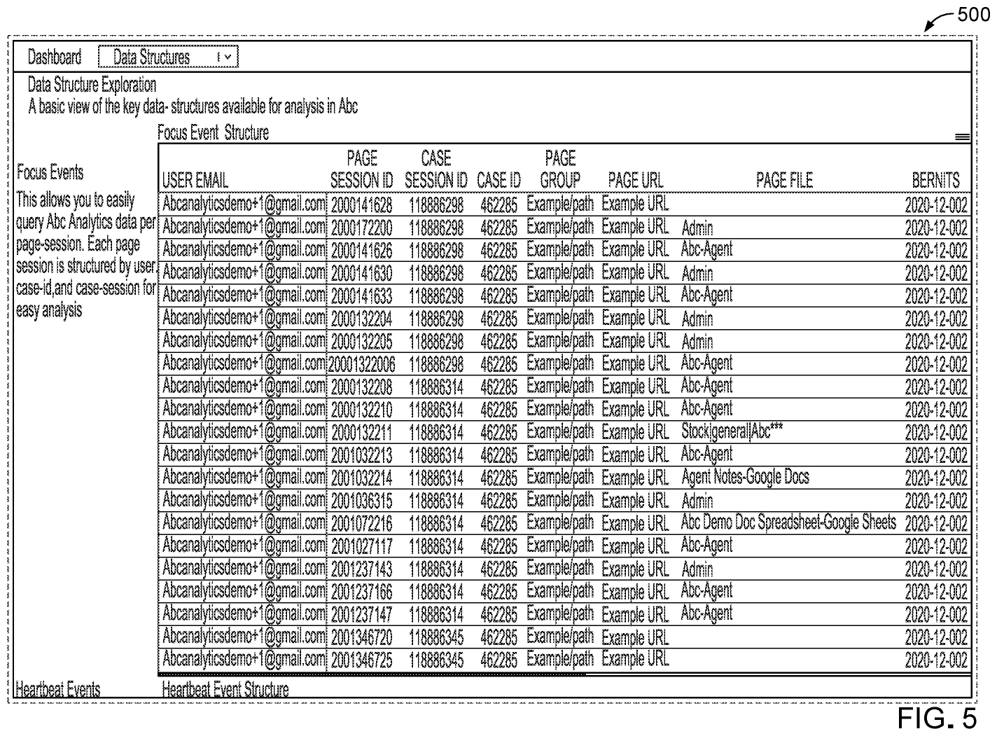

FIG. 5 is a screen shot of an example of a focus events structure 500, according to some implementations of the present disclosure. The focus events structure 500 can be used to capture and store information about page events. This can include information such as every single time the customer service agent switches pages or looks at a new resource, what case is associated, and which case session? The information can include multiple case sessions, the working customer service agent, how much time was spent, page refreshes, key presses, paste actions, and mouse scrolls.

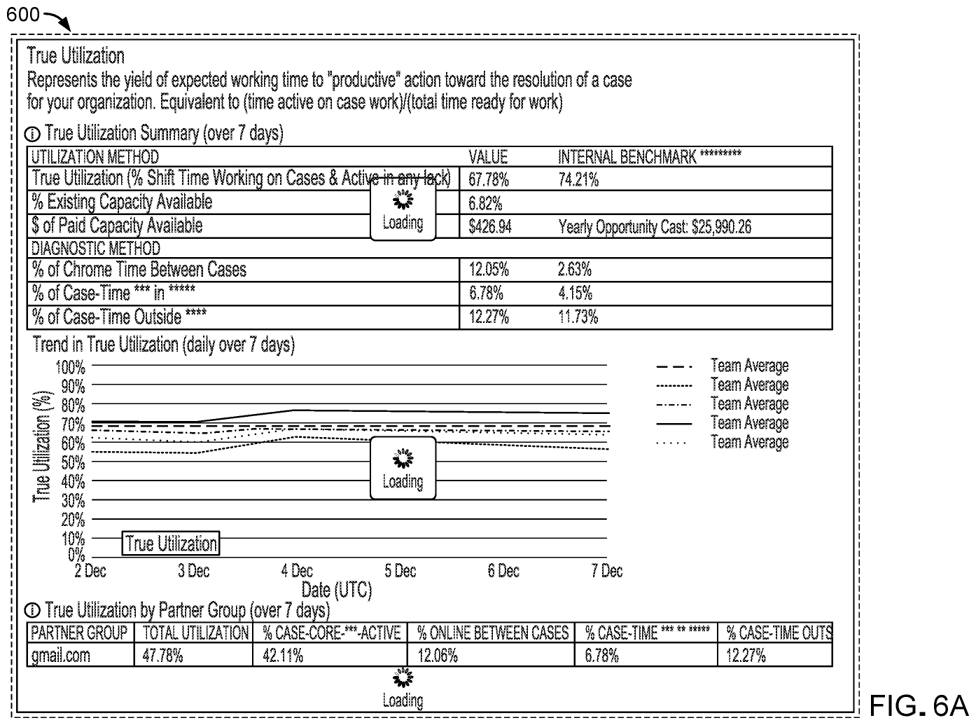

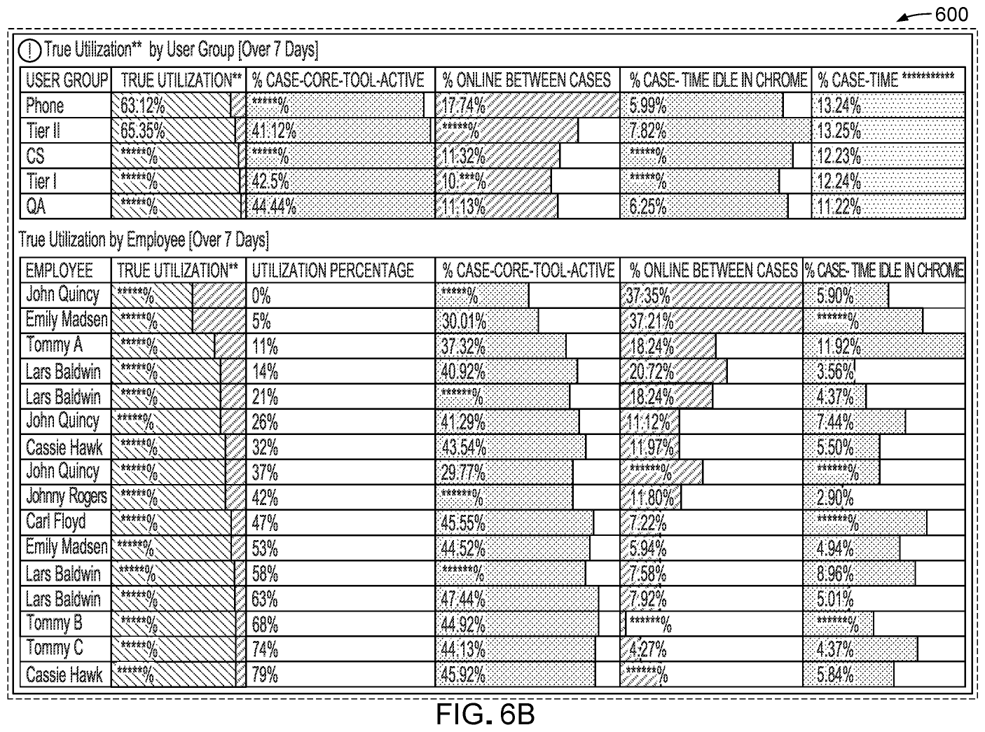

FIGS. 6A-6B are screen shots collectively showing an example of a true utilization page 600, according to some implementations of the present disclosure. The information includes heartbeats indicating, for every 60 seconds, how the CPU is performing, whether the customer service agent was active, page load events, page load times, open tabs, and slow times.

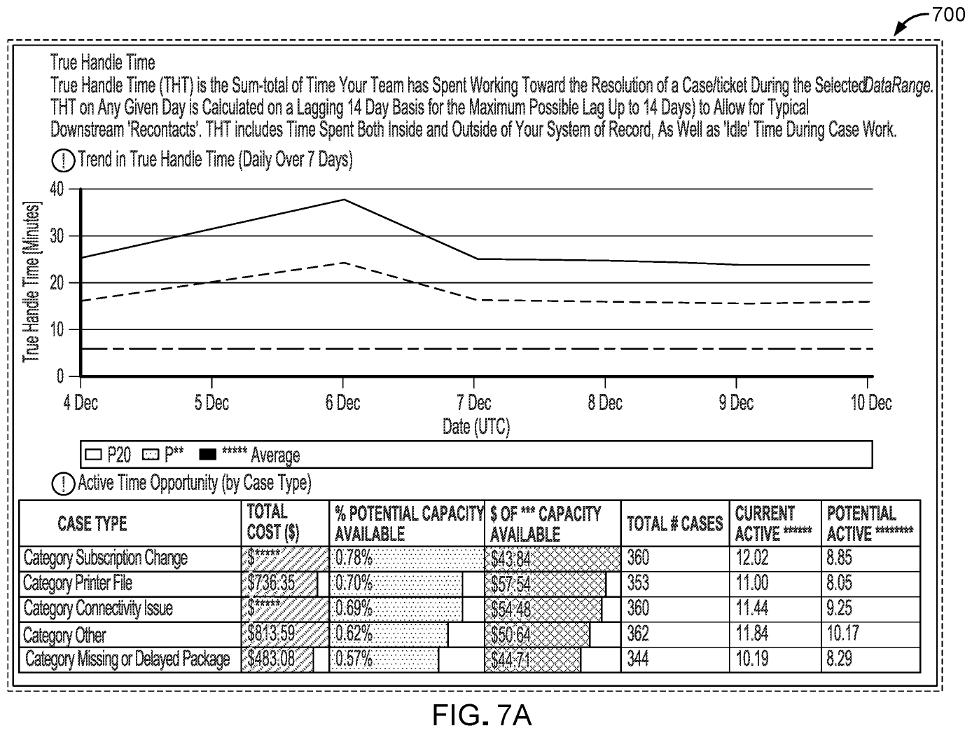

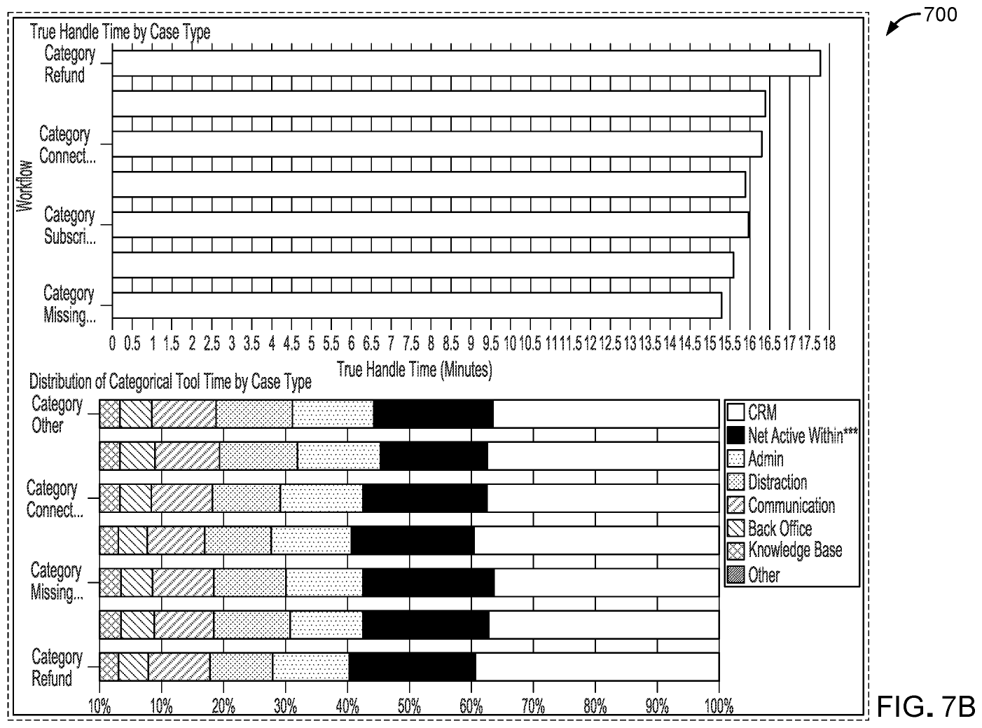

FIGS. 7A-7B are screen shots collectively showing an example of a true handle time page 700, according to some implementations of the present disclosure.

The system uses a Document Object Model (DOM) to monitor clicks, scrolls, and actual IDs of objects accessed, down to the class names. The DOM is a cross-platform and language-independent interface that treats an XML or HTML document as a tree structure, where each node is an object representing a part of the document. The DOM represents a document with a logical tree. Each branch of the tree ends in a node, and each node contains objects. DOM methods allow programmatic access to the tree. Nodes can have event handlers attached to them. Once an event is triggered, the event handlers are executed. The DOM information provides tracking of clicks, and the workflow analytics system can attach the tracked clicks and active page events to a corresponding case. This connection of clicks and active page events to a specified case can be used to understand, for each customer service agent, how active they are, and what opportunities exist for improving true handle times for a particular customer service agent.

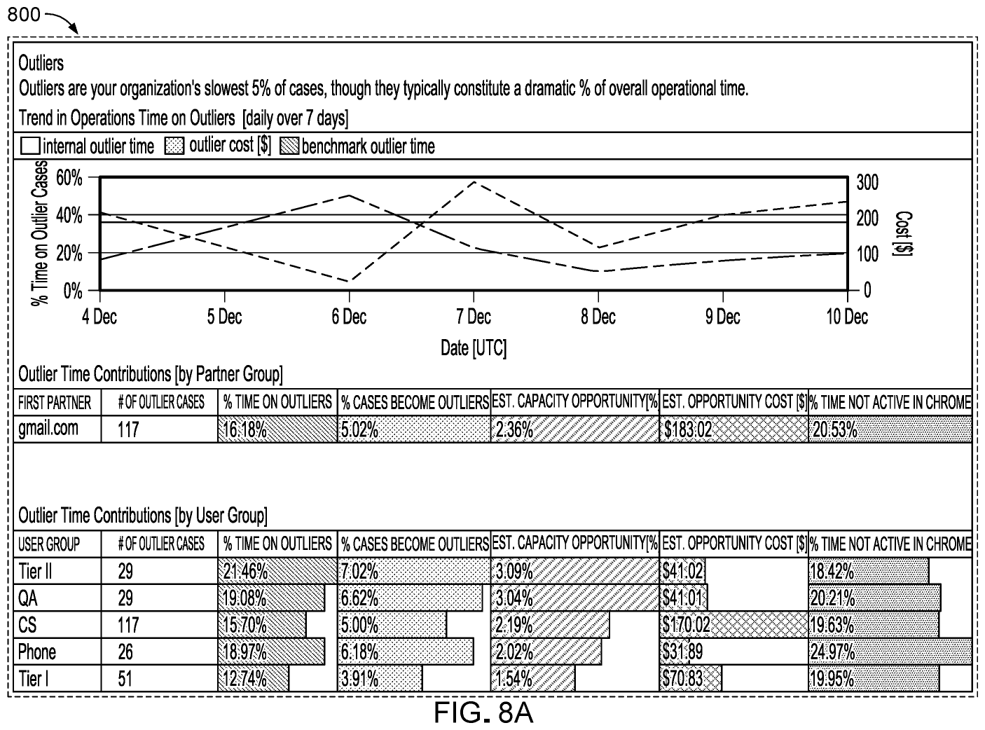

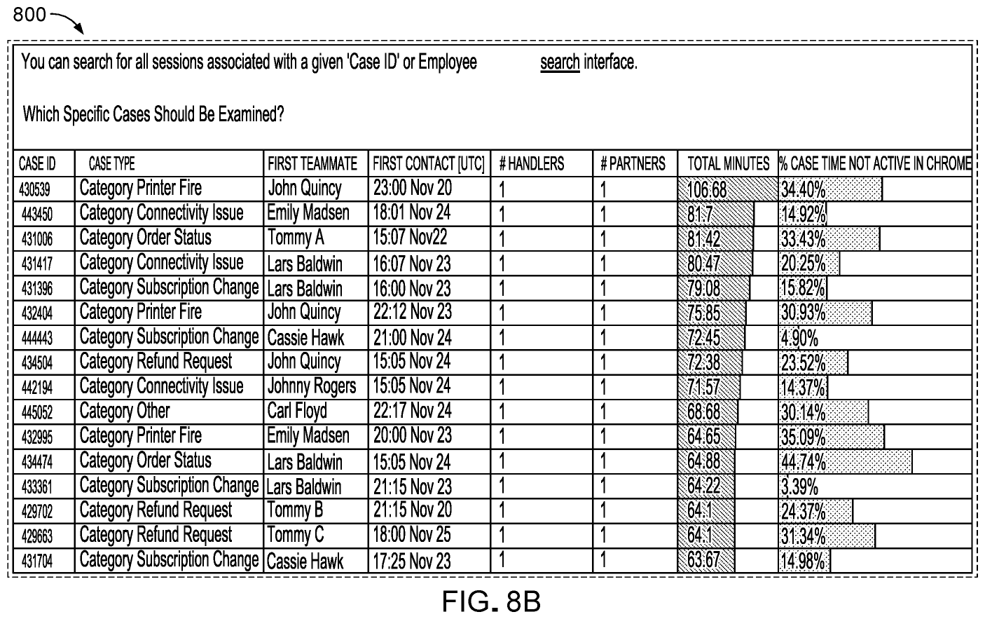

FIGS. 8A-8B are screen shots collectively showing an example of an outliers page 800, according to some implementations of the present disclosure. The outliers can identify the cases that are taking the longest.

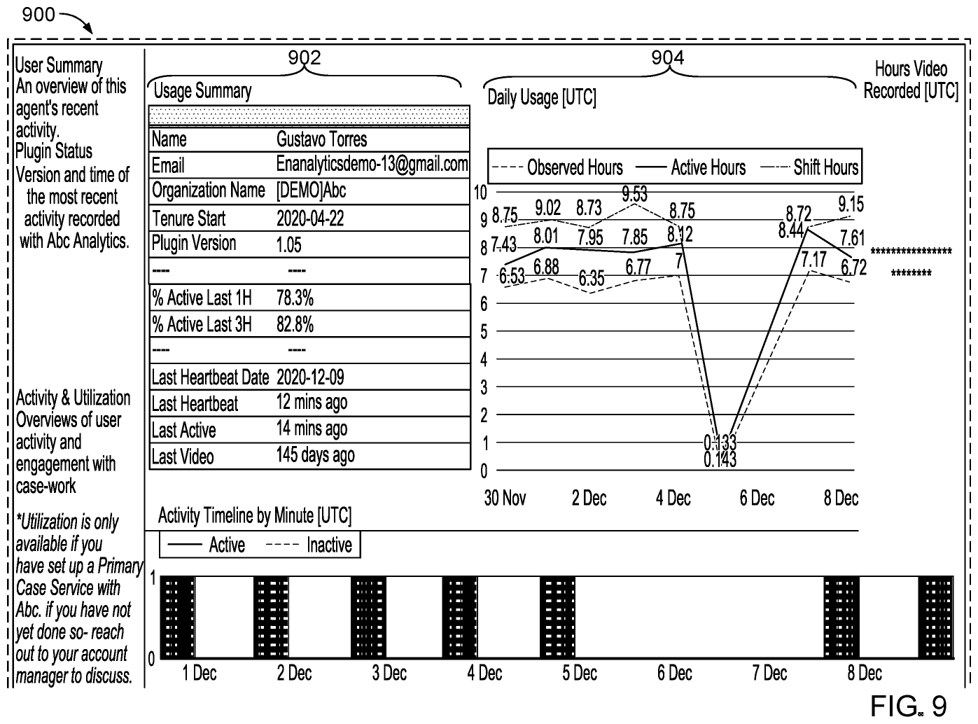

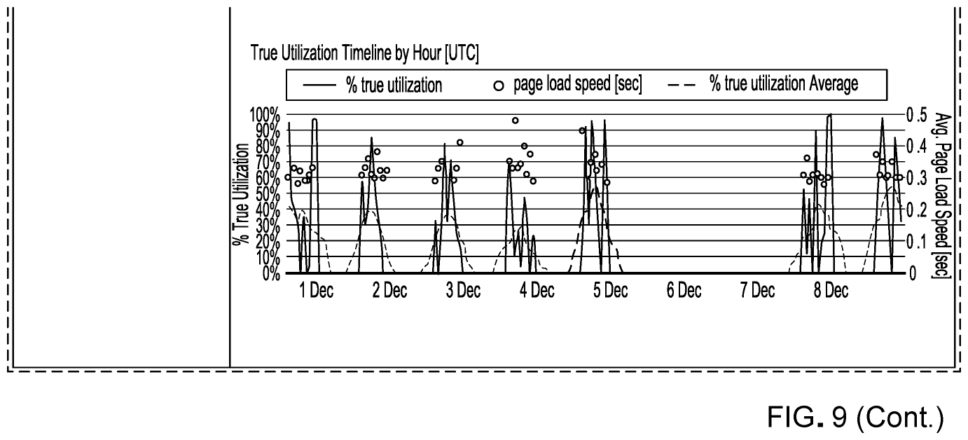

FIG. 9 is a screen shot of an example of a customer service agent summary page 900, according to some implementations of the present disclosure. The customer service agent summary page 900 includes a customer service agent summary area 902 that provides customer service agent profile information and productivity statistics for a customer service agent. A daily usage area 904 includes graphs showing customer service agent activity statistics (e.g., in hours) over time, identifying customer service agent shift hours, observed hours, and active hours.

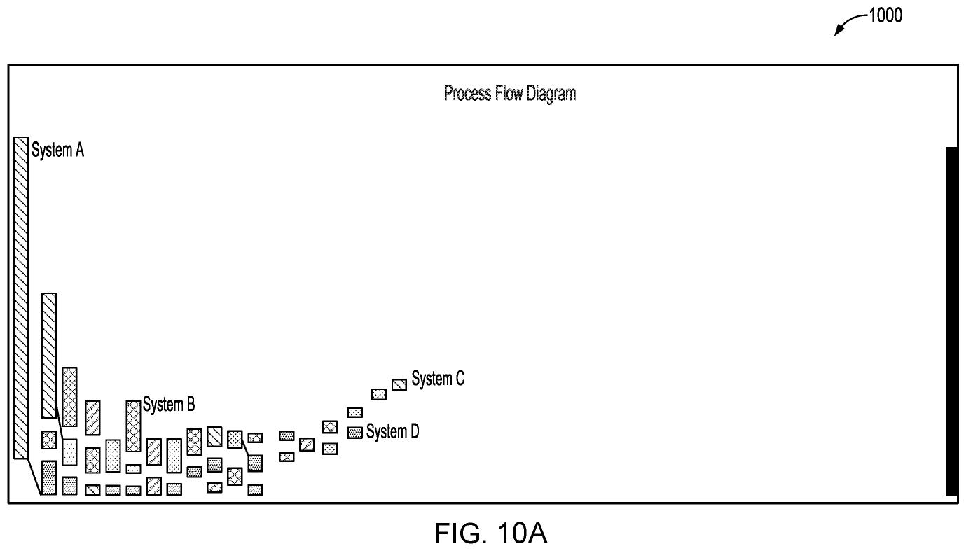

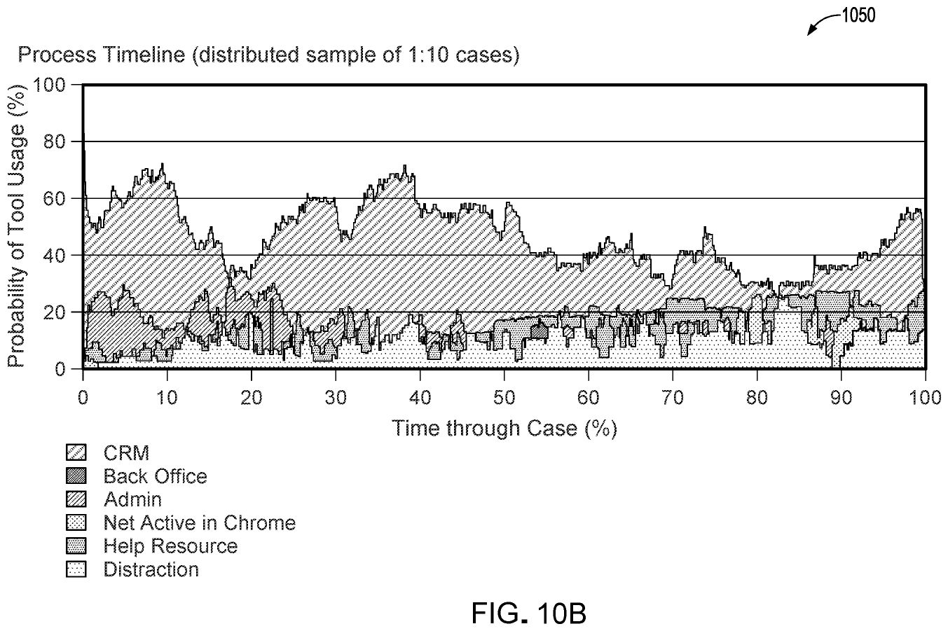

FIG. 10A is a screen shot of an example of a process flow diagram 1000, according to some implementations of the present disclosure. The diagram shows the most likely path to close a ticket based on active page events. Blocks in the diagram are arranged over time and indicate a progression of systems used by the customer service agent to work on the ticket. The blocks can be annotated with one or more of descriptive labels, shading, and color, for example, to indicate that the ticket started in CRM, moved to an administration (admin) tool, and then back to CRM.

FIG. 10B is a screen shot of an example of a process timeline 1050, according to some implementations of the present disclosure. The timeline can show the resources that were used and which ones were used a higher percentage of the time. This can identify where customer service agents are getting stuck and what is likely their next step.

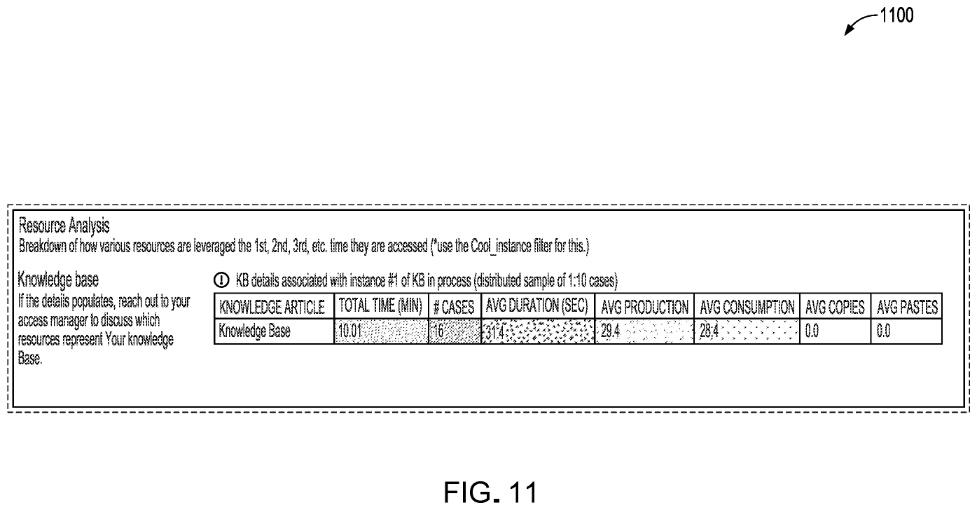

FIG. 11 is a screen shot of an example of a resource analysis page 1100, according to some implementations of the present disclosure.

FIG. 12 is a screen shot of an example of a trigger event definition page 1200, according to some implementations of the present disclosure. Trigger events effectively provide the ability to parse pages visited by a customer service agent while working on a given case. A trigger event can be used to parse the URL, for example, when a page matches XYZ, to extract the case ID out of it. This information can be used to identify how a new case is started. For example, a trigger condition can be set when the URL of a page (e.g., viewed by the customer service agent) matches a particular URL pattern, or when the title of the page matches a particular title pattern. Conditions defined on the trigger event definition page 1200 can be defined using Boolean operators for matches of URLS, titles, and HTML elements found on the page.

As an example, a trigger event can be defined for triggering a new case (or being associated with a current case) when a customer service agent navigates to a web page such as page 208a, having a specific URL. The page 208a can correspond to the first block in FIG. 10A, for example. Using defined trigger events a sequence of events can be tracked that occur in multiple software services being accessed by a customer service agent. The sequence of events can include one or more events from each case of a group of cases handled by the customer service agent. Using information extracted from one or more interactions of the customer service agent with at least one service, focus events can be determined that identify which case in the group of cases is being worked on by the customer service agent at various points in time, with each focus event having a focus event duration. Each focus event can be assigned to a particular case using the extracted information. A total period of time spent by the customer service agent on the particular case can be determined based on a sum of focus events durations for the focus events assigned to the particular case.

In an example, when a trigger (e.g., a page view) occurs, additional controls that are available from the trigger event definition page 1200 can be used to define certain responses that are to happen (or be triggered, in addition to logging the event). The responses can include, for example, creating an activity (e.g., marking this moment, or timestamp, in time), sending an email, sending a workbook, providing a Chrome notification, or redacting video. Marking the moment can cause the moment to be labeled on the timeline of the video playback area 404, for example.

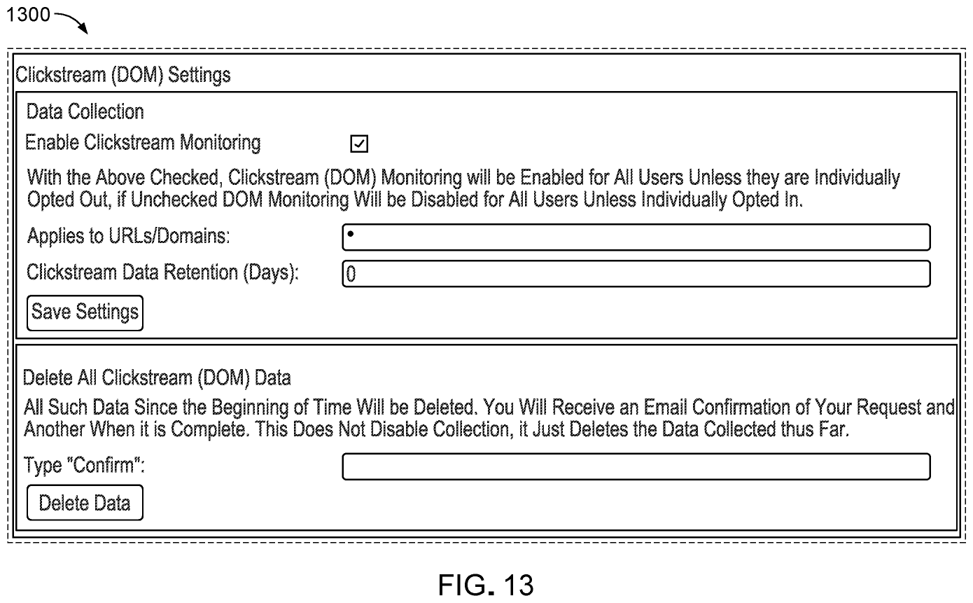

FIG. 13 is a screen shot of an example of a clickstream page 1300, according to some implementations of the present disclosure. The clickstream page 1300 can be used to identify specific data that is to be monitored and collected. Monitoring performed by the clickstream page 1300 can be filtered or limited based on opt-in and opt-out preferences set for specific customer service agents. Settings in the clickstream page 1300 can be used to define specific pages (e.g., by URL) that are to be used in monitoring and to specify a data retention time (e.g., a number of days) for monitored information. Clickstream deletion time fields can be used to control when existing clickstream data is to be deleted.

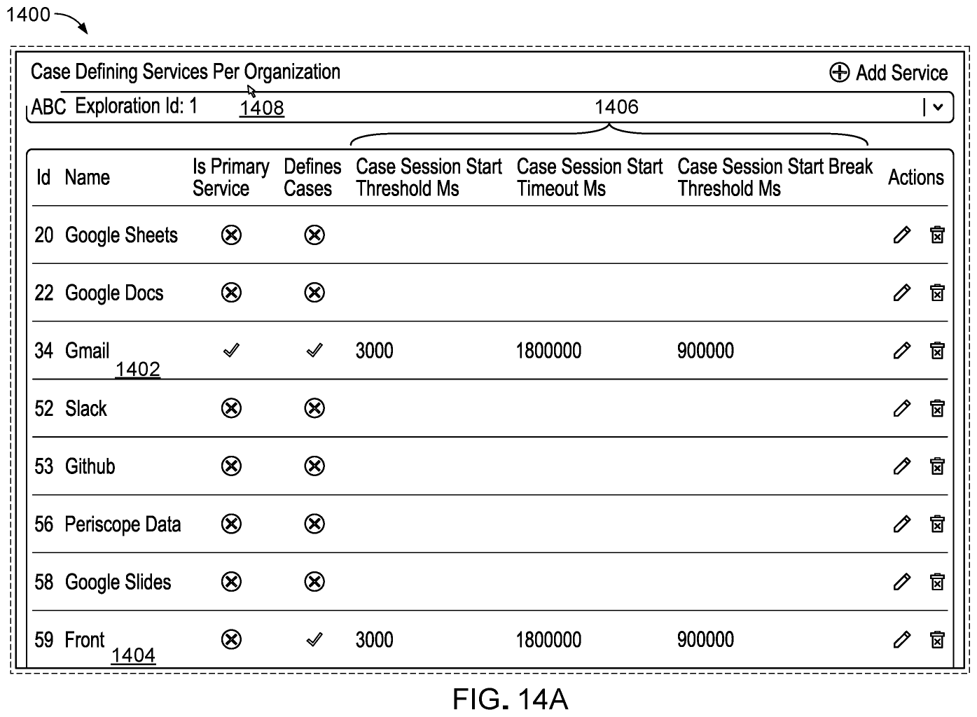

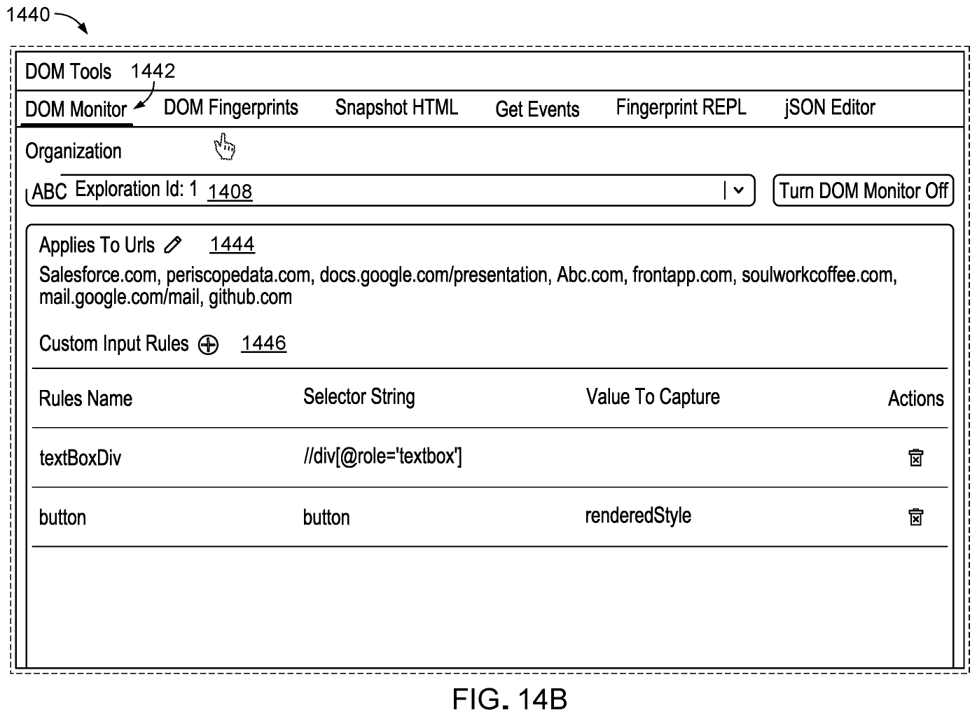

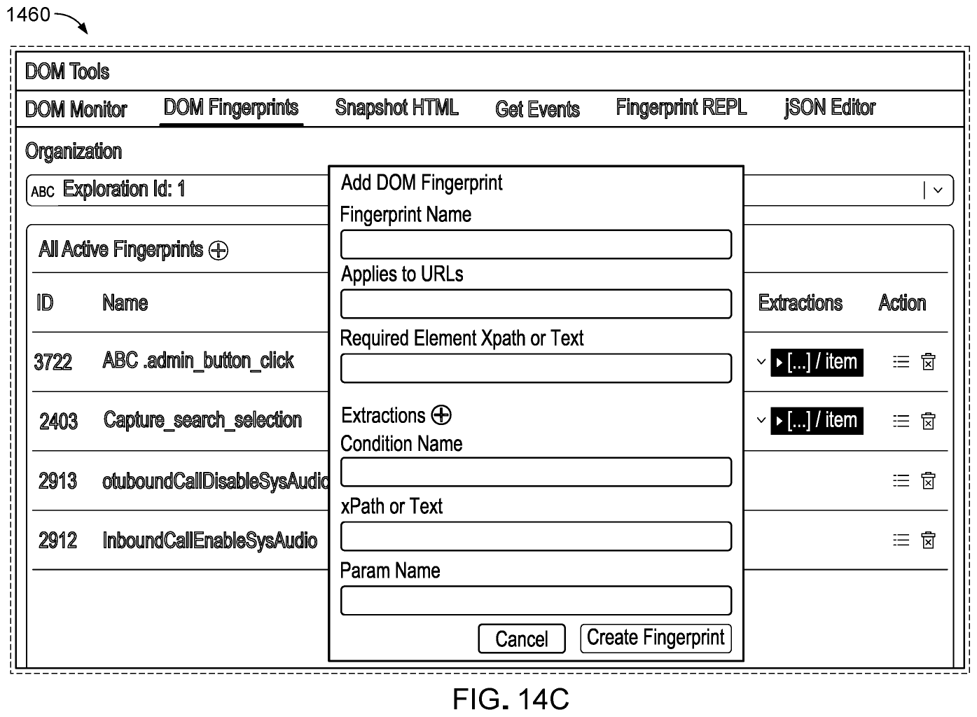

FIG. 14A is a screen shot of an example of a case defining services per organization page 1400, according to some implementations of the present disclosure. The page 1400 allows a user (such as an Administrator of agent monitoring) to identify which services apply to an organization's cases. The definitions identify the names of services and time thresholds (e.g., start, timeout, and break times) that are used to link customer service agent actions to a case. For example, for the case currently defined on the page 1400, fields of the page define a Gmail app 1402 and a Front app 1404, with time thresholds 1406, as being the apps used for cases in Organization ABC 1408. The start time indicates a minimum time that a case is in view before the case is considered being worked on by the customer support agent. Doing this avoids assigning time to a case when the customer support agent tabs through information for the case for only a moment.

FIG. 14B is a screen shot showing an example of a DOM tools page 1440, according to some implementations of the present disclosure. For a currently-selected DOM monitor option 1442, a URLs list 1444 identifies the current list of URLs that DOM settings apply to for the organization 1408. A rules section 1446 facilitates the definition of rules associated with DOM monitoring, including write a rule, for example, that defines a path of an element that starts or ends a specific case.

FIG. 14C is a screen shot showing an example of an add DOM fingerprint page 1460, according to some implementations of the present disclosure. The DOM fingerprint page provides the ability to define a fingerprint that effectively captures the path of an element effectively starting and/or ending a specific case. The fingerprint can apply, for example, to a key press, entry in a field, starting a recording, or some other action.

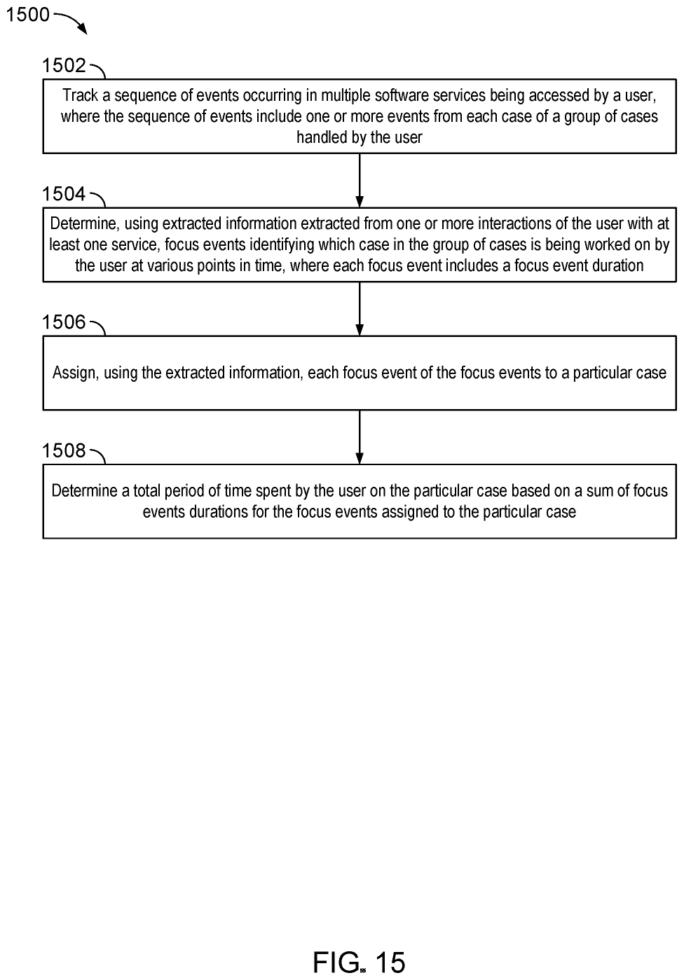

FIG. 15 is a flowchart of an example of a method 1500 for determining time spent by the customer service agent on the particular case, according to some implementations of the present disclosure. For example, the system 200 can be used to perform the method 1500. For clarity of presentation, the description that follows generally describes method 1500 in the context of the other figures in this description. However, it will be understood that method 1500 can be performed, for example, by any suitable system, environment, software, and hardware, or a combination of systems, environments, software, and hardware, as appropriate. In some implementations, various steps of method 1500 can be run in parallel, in combination, in loops, or in any order.

At 1502, a sequence of events occurring in multiple software services being accessed by a user (e.g., a customer service agent) is tracked. The multiple software services can include web pages, documents, spreadsheets, workflows, desktop applications, and conversations on communication devices. As an example, the multiple software services can include web pages used by the user within a CRM system, and the user can be a customer service representative. The sequence of events includes one or more events from each case of a group of cases handled by the user. For example, tracking the sequence of events can include the following. In some implementations, the multiple software services can include at least a software service of a first type and a software service of a second type, where the first type is CRM software and the second type is a search engine.

Focus events are recorded that identify page switches by the customer service agent, views of a new resource by the customer service agent, where each focus event identifies the customer service agent, an associated case, an associated session, a time spent on a particular page, whether the particular page was refreshed, keys that were pressed, copy-paste actions that were taken, and mouse scrolls that occurred. Heartbeats are recorded at a threshold heartbeat interval (for example, once every 60 seconds). The heartbeats can indicate CPU performance and whether the customer service agent has been active (and to what degree). Page load events are recorded including identifying a time to process a page load request, a time to finish loading the page, a number of tabs that are open, and whether a page load was slow. DOM events are recorded, including clicks by the customer service agent, scrolling by the customer service agent, an identifier of a software service, a class name and a subclass name of the software service, and content of text typed into the software service.

In some implementations, tracking the sequence of events can include setting identifier threshold rules defining a set of identifiers used in a set of systems that are to be tracked, disregarding identifiers not included in a tracked subset of the multiple software services, recording timestamps for start and end times on a particular software service, and disregarding, using the start and end times, identifiers corresponding to events that last less than a threshold event duration.

In some implementations, tracking the sequence of events can include collecting active page events, page level events, machine heartbeats, DOM events, video, audio, times when the customer service agent is speaking versus not speaking, times when the customer service agent is using video, entries written to documents, desktop application events, and entries extracted from the documents. From 1502, method 1500 proceeds to 1504.

At 1504, focus events identifying which case in the group of cases is being worked on by the customer service agent at various points in time are determined using information extracted from one or more interactions of the customer service agent with at least one service, where each focus event includes a focus event duration. From 1504, method 1500 proceeds to 1506.

At 1506, each focus event of the focus events is assigned to a particular case using the extracted information. For example, assigning each focus event of the focus events to a particular case can include linking previously unlinked identifiers from the software services by observing an expected behavioral pattern for using the multiple software services in a particular order pattern to respond to and close the particular case. In some implementations, the expected behavioral pattern can be company-dependent. In some implementations, the expected behavioral pattern can include ICIs including a timeframe defining an amount of time between a start time of the particular case and a next step performed by the customer service agent on the particular case. From 1506, method 1500 proceeds to 1508.

At 1508, a total period of time spent by the customer service agent on the particular case is determined based on a sum of focus event durations for the focus events assigned to the particular case. As an example, assigning a focus event to the particular case can include using clustering algorithms to identify and cluster a same customer corresponding to the particular case across the multiple software services. After 1508, method 1500 can stop.

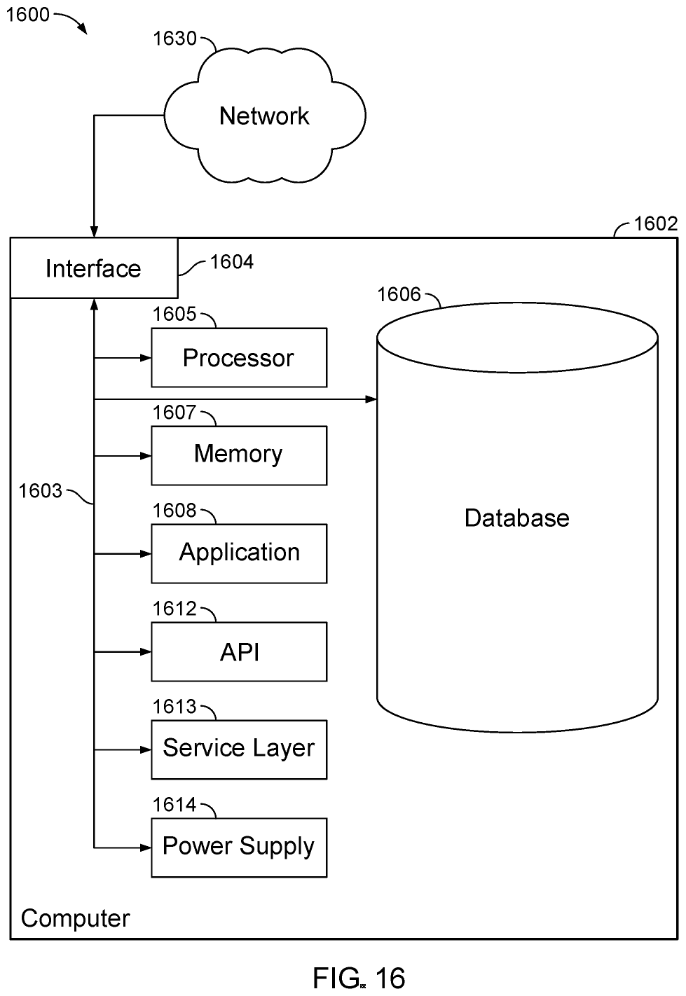

FIG. 16 is a block diagram of an example computer system 1600 used to provide computational functionalities associated with described algorithms, methods, functions, processes, flows, and procedures described in the present disclosure, according to some implementations of the present disclosure. The illustrated computer 1602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1602 can include input devices such as keypads, keyboards, and touch screens that can accept user information. Also, the computer 1602 can include output devices that can convey information associated with the operation of the computer 1602. The information can include digital data, visual data, audio information, or a combination of information. The information can be presented in a graphical user interface (UI) (or GUI).

The computer 1602 can serve in a role as a client, a network component, a server, a database, a persistency, or components of a computer system for performing the subject matter described in the present disclosure. The illustrated computer 1602 is communicably coupled with a network 1630. In some implementations, one or more components of the computer 1602 can be configured to operate within different environments, including cloud-computing-based environments, local environments, global environments, and combinations of environments.

At a top level, the computer 1602 is an electronic computing device operable to receive, transmit, process, store, and manage data and information associated with the described subject matter. According to some implementations, the computer 1602 can also include, or be communicably coupled with, an application server, an email server, a web server, a caching server, a streaming data server, or a combination of servers.

The computer 1602 can receive requests over network 1630 from a client application (for example, executing on another computer 1602). The computer 1602 can respond to the received requests by processing the received requests using software applications. Requests can also be sent to the computer 1602 from internal users (for example, from a command console), external (or third) parties, automated applications, entities, individuals, systems, and computers.

Each of the components of the computer 1602 can communicate using a system bus 1603. In some implementations, any or all of the components of the computer 1602, including hardware or software components, can interface with each other or the interface 1604 (or a combination of both) over the system bus 1603. Interfaces can use an application programming interface (API) 1612, a service layer 1613, or a combination of the API 1612 and service layer 1613. The API 1612 can include specifications for routines, data structures, and object classes. The API 1612 can be either computer-language independent or dependent. The API 1612 can refer to a complete interface, a single function, or a set of APIs.

The service layer 1613 can provide software services to the computer 1602 and other components (whether illustrated or not) that are communicably coupled to the computer 1602. The functionality of the computer 1602 can be accessible for all service consumers using this service layer. Software services, such as those provided by the service layer 1613, can provide reusable, defined functionalities through a defined interface. For example, the interface can be software written in JAVA, C++, or a language providing data in extensible markup language (XML) format. While illustrated as an integrated component of the computer 1602, in alternative implementations, the API 1612 or the service layer 1613 can be stand-alone components in relation to other components of the computer 1602 and other components communicably coupled to the computer 1602. Moreover, any or all parts of the API 1612 or the service layer 1613 can be implemented as child or sub-modules of another software module, enterprise application, or hardware module without departing from the scope of the present disclosure.

The computer 1602 includes an interface 1604. Although illustrated as a single interface 1604 in FIG. 16, two or more interfaces 1604 can be used according to particular needs, desires, or particular implementations of the computer 1602 and the described functionality. The interface 1604 can be used by the computer 1602 for communicating with other systems that are connected to the network 1630 (whether illustrated or not) in a distributed environment. Generally, the interface 1604 can include, or be implemented using, logic encoded in software or hardware (or a combination of software and hardware) operable to communicate with the network 1630. More specifically, the interface 1604 can include software supporting one or more communication protocols associated with communications. As such, the network 1630 or the interface's hardware can be operable to communicate physical signals within and outside of the illustrated computer 1602.

The computer 1602 includes a processor 1605. Although illustrated as a single processor 1605 in FIG. 16, two or more processors 1605 can be used according to particular needs, desires, or particular implementations of the computer 1602 and the described functionality. Generally, the processor 1605 can execute instructions and can manipulate data to perform the operations of the computer 1602, including operations using algorithms, methods, functions, processes, flows, and procedures as described in the present disclosure.

The computer 1602 also includes a database 1606 that can hold data for the computer 1602 and other components connected to the network 1630 (whether illustrated or not). For example, database 1606 can be an in-memory, conventional, or a database storing data consistent with the present disclosure. In some implementations, database 1606 can be a combination of two or more different database types (for example, hybrid in-memory and conventional databases) according to particular needs, desires, or particular implementations of the computer 1602 and the described functionality. Although illustrated as a single database 1606 in FIG. 16, two or more databases (of the same, different, or combination of types) can be used according to particular needs, desires, or particular implementations of the computer 1602 and the described functionality. While database 1606 is illustrated as an internal component of the computer 1602, in alternative implementations, database 1606 can be external to the computer 1602.

The computer 1602 also includes a memory 1607 that can hold data for the computer 1602 or a combination of components connected to the network 1630 (whether illustrated or not). Memory 1607 can store any data consistent with the present disclosure. In some implementations, memory 1607 can be a combination of two or more different types of memory (for example, a combination of semiconductor and magnetic storage) according to particular needs, desires, or particular implementations of the computer 1602 and the described functionality. Although illustrated as a single memory 1607 in FIG. 16, two or more memories 1607 (of the same, different, or combination of types) can be used according to particular needs, desires, or particular implementations of the computer 1602 and the described functionality. While memory 1607 is illustrated as an internal component of the computer 1602, in alternative implementations, memory 1607 can be external to the computer 1602.

The application 1608 can be an algorithmic software engine providing functionality according to particular needs, desires, or particular implementations of the computer 1602 and the described functionality. For example, application 1608 can serve as one or more components, modules, or applications. Further, although illustrated as a single application 1608, the application 1608 can be implemented as multiple applications 1608 on the computer 1602. In addition, although illustrated as internal to the computer 1602, in alternative implementations, the application 1608 can be external to the computer 1602.

The computer 1602 can also include a power supply 1614. The power supply 1614 can include a rechargeable or non-rechargeable battery that can be configured to be either user- or non-user-replaceable. In some implementations, the power supply 1614 can include power-conversion and management circuits, including recharging, standby, and power management functionalities. In some implementations, the power-supply 1614 can include a power plug to allow the computer 1602 to be plugged into a wall socket or a power source to, for example, power the computer 1602 or recharge a rechargeable battery.

There can be any number of computers 1602 associated with, or external to, a computer system containing computer 1602, with each computer 1602 communicating over network 1630. Further, the terms “client,” “user,” and other appropriate terminology can be used interchangeably, as appropriate, without departing from the scope of the present disclosure. Moreover, the present disclosure contemplates that many users can use one computer 1602 and one user can use multiple computers 1602.

Described implementations of the subject matter can include one or more features, alone or in combination.

For example, in a first implementation, a computer-implemented method includes the following. A sequence of events occurring in multiple software services being accessed by a user is tracked. The sequence of events includes one or more events from each case of a group of cases handled by the user. Using information extracted from one or more interactions of the user with at least one service, focus events are determined that identify which case in the group of cases is being worked on by the user at various points in time, each focus event having a focus event duration. Using the extracted information, each focus event of the focus events is assigned to a particular case. A total period of time spent by the user on the particular case is determined based on a sum of focus events durations for the focus events assigned to the particular case.

The foregoing and other described implementations can each, optionally, include one or more of the following features:

A first feature, combinable with any of the following features, where tracking the sequence of events includes: recording focus events identifying page switches by the user, views of a new resource by the user, wherein each focus event identifies the user, an associated case, an associated session, a time spent on a particular page, whether the particular page was refreshed, keys that were pressed, copy-paste actions that were taken, and mouse scrolls that occurred; recording heartbeats at a threshold heartbeat interval indicating central processing unit (CPU) performance and whether the user was active; recording page load events including identifying a time to process a page load request, a time to finish loading the page, a number of tabs that are open, and whether a page load was slow; and recording document object model (DOM) including clicks by the user, scrolling by the user, an identifier of a software service, a class name and a subclass name of the software service, and content of text typed into the software service.

A second feature, combinable with any of the previous or following features, where tracking the sequence of events includes: setting identifier threshold rules defining a set of identifiers used in set of systems that are to be tracked; disregarding identifiers not included in a tracked subset of the multiple software services; recording timestamps for start and end times on a particular software service; and disregarding, using the start and end times, identifiers corresponding to events that last less than a threshold event duration.

A third feature, combinable with any of the previous or following features, where assigning each focus event of the focus events to a particular case includes linking previously unlinked identifiers from the software services by observing an expected behavioral pattern for using the multiple software services in a particular order pattern to respond to and close the particular case.

A fourth feature, combinable with any of the previous or following features, where the expected behavioral pattern is company-dependent.

A fifth feature, combinable with any of the previous or following features, where the expected behavioral pattern includes input context intervals (ICIs) including a timeframe defining an amount of time between a start time of the particular case and a next step performed by the user on the particular case.

A sixth feature, combinable with any of the previous or following features, where the multiple software services include web pages, documents, spreadsheets, workflows, desktop applications, and conversations on communication devices.

A seventh feature, combinable with any of the previous or following features, tracking the sequence of events includes collecting active page events, page level events, machine heartbeats, DOM events, video, audio, times when the user is speaking versus not speaking, times when the user is using video, entries written to documents, desktop application events, and entries extracted from the documents.

An eighth feature, combinable with any of the previous or following features, where assigning a focus event to the particular case includes using clustering algorithms to identify and cluster a same customer corresponding to the particular case across the multiple software services.

A ninth feature, combinable with any of the previous or following features, where the multiple software services include web pages used by the user within a customer relationship management (CRM) system and wherein the user is a customer service representative.

A tenth feature, combinable with any of the previous or following features, where the multiple software services comprise at least a software service of a first type and a software service of a second type, and wherein the software service of the first type and the software service of the second type are uncoordinated software services lacking inter-service communication and a common identification labelling system.

An eleventh feature, combinable with any of the previous or following features, where the first type is CRM software and the second type is a search engine.

In a second implementation, a non-transitory, computer-readable medium stores one or more instructions executable by a computer system to perform operations including the following. A sequence of events occurring in multiple software services being accessed by a user is tracked. The sequence of events includes one or more events from each case of a group of cases handled by the user. Using information extracted from one or more interactions of the user with at least one service, focus events are determined that identify which case in the group of cases is being worked on by the user at various points in time, each focus event having a focus event duration. Using the extracted information, each focus event of the focus events is assigned to a particular case. A total period of time spent by the user on the particular case is determined based on a sum of focus events durations for the focus events assigned to the particular case.

The foregoing and other described implementations can each, optionally, include one or more of the following features:

A first feature, combinable with any of the following features, where tracking the sequence of events includes: recording focus events identifying page switches by the user, views of a new resource by the user, wherein each focus event identifies the user, an associated case, an associated session, a time spent on a particular page, whether the particular page was refreshed, keys that were pressed, copy-paste actions that were taken, and mouse scrolls that occurred; recording heartbeats at a threshold heartbeat interval indicating central processing unit (CPU) performance and whether the user was active; recording page load events including identifying a time to process a page load request, a time to finish loading the page, a number of tabs that are open, and whether a page load was slow; and recording document object model (DOM) including clicks by the user, scrolling by the user, an identifier of a software service, a class name and a subclass name of the software service, and content of text typed into the software service.

A second feature, combinable with any of the previous or following features, where tracking the sequence of events includes: setting identifier threshold rules defining a set of identifiers used in set of systems that are to be tracked; disregarding identifiers not included in a tracked subset of the multiple software services; recording timestamps for start and end times on a particular software service; and disregarding, using the start and end times, identifiers corresponding to events that last less than a threshold event duration.

A third feature, combinable with any of the previous or following features, where assigning each focus event of the focus events to a particular case includes linking previously unlinked identifiers from the software services by observing an expected behavioral pattern for using the multiple software services in a particular order pattern to respond to and close the particular case.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. A sequence of events occurring in multiple software services being accessed by a user is tracked. The sequence of events includes one or more events from each case of a group of cases handled by the user. Using information extracted from one or more interactions of the user with at least one service, focus events are determined that identify which case in the group of cases is being worked on by the user at various points in time, each focus event having a focus event duration. Using the extracted information, each focus event of the focus events is assigned to a particular case. A total period of time spent by the user on the particular case is determined based on a sum of focus events durations for the focus events assigned to the particular case.

The foregoing and other described implementations can each, optionally, include one or more of the following features:

A first feature, combinable with any of the following features, where tracking the sequence of events includes: recording focus events identifying page switches by the user, views of a new resource by the user, wherein each focus event identifies the user, an associated case, an associated session, a time spent on a particular page, whether the particular page was refreshed, keys that were pressed, copy-paste actions that were taken, and mouse scrolls that occurred; recording heartbeats at a threshold heartbeat interval indicating central processing unit (CPU) performance and whether the user was active; recording page load events including identifying a time to process a page load request, a time to finish loading the page, a number of tabs that are open, and whether a page load was slow; and recording document object model (DOM) including clicks by the user, scrolling by the user, an identifier of a software service, a class name and a subclass name of the software service, and content of text typed into the software service.

A second feature, combinable with any of the previous or following features, where tracking the sequence of events includes: setting identifier threshold rules defining a set of identifiers used in set of systems that are to be tracked; disregarding identifiers not included in a tracked subset of the multiple software services; recording timestamps for start and end times on a particular software service; and disregarding, using the start and end times, identifiers corresponding to events that last less than a threshold event duration.

A third feature, combinable with any of the previous or following features, where assigning each focus event of the focus events to a particular case includes linking previously unlinked identifiers from the software services by observing an expected behavioral pattern for using the multiple software services in a particular order pattern to respond to and close the particular case.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/-R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
tracking a sequence of events occurring in multiple software services being accessed by a user, the sequence of events including one or more events from each case of a group of cases handled by the user;
determining, using information extracted from one or more interactions of the user with at least one service, focus events identifying which case in the group of cases is being worked on by the user at various points in time, each focus event having a focus event duration;
assigning, using the extracted information, each focus event of the focus events to a particular case; and
determining a total period of time spent by the user on the particular case based on a sum of focus events durations for the focus events assigned to the particular case.

2. The computer-implemented method of claim 1, wherein tracking the sequence of events includes:
recording focus events identifying page switches by the user, views of a new resource by the user, wherein each focus event identifies the user, an associated case, an associated session, a time spent on a particular page, whether the particular page was refreshed, keys that were pressed, copy-paste actions that were taken, and mouse scrolls that occurred;
recording heartbeats at a threshold heartbeat interval indicating central processing unit (CPU) performance and whether the user was active;
recording page load events including identifying a time to process a page load request, a time to finish loading the page, a number of tabs that are open, and whether a page load was slow; and
recording document object model (DOM) including clicks by the user, scrolling by the user, an identifier of a software service, a class name and a subclass name of the software service, and content of text typed into the software service.

3. The computer-implemented method of claim 1, wherein tracking the sequence of events includes:
setting identifier threshold rules defining a set of identifiers used in set of systems that are to be tracked;
disregarding identifiers not included in a tracked subset of the multiple software services;
recording timestamps for start and end times on a particular software service; and
disregarding, using the start and end times, identifiers corresponding to events that last less than a threshold event duration.

4. The computer-implemented method of claim 1, wherein assigning each focus event of the focus events to a particular case includes linking previously unlinked identifiers from the software services by observing an expected behavioral pattern for using the multiple software services in a particular order pattern to respond to and close the particular case.

5. The computer-implemented method of claim 4, wherein the expected behavioral pattern is company-dependent.

6. The computer-implemented method of claim 4, wherein the expected behavioral pattern includes input context intervals (ICIs) including a timeframe defining an amount of time between a start time of the particular case and a next step performed by the user on the particular case.

7. The computer-implemented method of claim 1, wherein the multiple software services include web pages, documents, spreadsheets, workflows, desktop applications, and conversations on communication devices.

8. The computer-implemented method of claim 1, wherein tracking the sequence of events includes collecting active page events, page level events, machine heartbeats, DOM events, video, audio, times when the user is speaking versus not speaking, times when the user is using video, entries written to documents, desktop application events, and entries extracted from the documents.

9. The computer-implemented method of claim 1, wherein assigning a focus event to the particular case includes using clustering algorithms to identify and cluster a same customer corresponding to the particular case across the multiple software services.

10. The computer-implemented method of claim 1, wherein the multiple software services include web pages used by the user within a customer relationship management (CRM) system and wherein the user is a customer service representative.

11. The computer-implemented method of claim 1, wherein the multiple software services comprise at least a software service of a first type and a software service of a second type, and wherein the software service of the first type and the software service of the second type are uncoordinated software services lacking inter-service communication and a common identification labelling system.

12. The computer-implemented method of claim 11, wherein the first type is CRM software and the second type is a search engine.

13. One or more non-transitory, computer-readable storage media encoded with instructions that, when executed by one or more computers, cause the one or more computers to perform operations comprising:
tracking a sequence of events occurring in multiple software services being accessed by a user, the sequence of events including one or more events from each case of a group of cases handled by the user;
determining, using information extracted from one or more interactions of the user with at least one service, focus events identifying which case in the group of cases is being worked on by the user at various points in time, each focus event having a focus event duration;
assigning, using the extracted information, each focus event of the focus events to a particular case; and
determining a total period of time spent by the user on the particular case based on a sum of focus events durations for the focus events assigned to the particular case.

14. The one or more non-transitory, computer-readable storage media of claim 13, wherein tracking the sequence of events includes:
recording focus events identifying page switches by the user, views of a new resource by the user, wherein each focus event identifies the user, an associated case, an associated session, a time spent on a particular page, whether the particular page was refreshed, keys that were pressed, copy-paste actions that were taken, and mouse scrolls that occurred;
recording heartbeats at a threshold heartbeat interval indicating central processing unit (CPU) performance and whether the user was active;
recording page load events including identifying a time to process a page load request, a time to finish loading the page, a number of tabs that are open, and whether a page load was slow; and
recording document object model (DOM) including clicks by the user, scrolling by the user, an identifier of a software service, a class name and a subclass name of the software service, and content of text typed into the software service.

15. The one or more non-transitory, computer-readable storage media of claim 13, wherein tracking the sequence of events includes:
setting identifier threshold rules defining a set of identifiers used in set of systems that are to be tracked;
disregarding identifiers not included in a tracked subset of the multiple software services;
recording timestamps for start and end times on a particular software service; and
disregarding, using the start and end times, identifiers corresponding to events that last less than a threshold event duration.

16. The one or more non-transitory, computer-readable storage media of claim 13, wherein assigning each focus event of the focus events to a particular case includes linking previously unlinked identifiers from the software services by observing an expected behavioral pattern for using the multiple software services in a particular order pattern to respond to and close the particular case.

17. A computer-implemented system, comprising:
one or more computers and one or more storage devices on which are stored instructions that are operable, when executed by the one or more computers, to cause the one or more computers to perform operations comprising:
tracking a sequence of events occurring in multiple software services being accessed by a user, the sequence of events including one or more events from each case of a group of cases handled by the user;
determining, using information extracted from one or more interactions of the user with at least one service, focus events identifying which case in the group of cases is being worked on by the user at various points in time, each focus event having a focus event duration;
assigning, using the extracted information, each focus event of the focus events to a particular case; and
determining a total period of time spent by the user on the particular case based on a sum of focus events durations for the focus events assigned to the particular case.

18. The computer-implemented system of claim 17, wherein tracking the sequence of events includes:
recording focus events identifying page switches by the user, views of a new resource by the user, wherein each focus event identifies the user, an associated case, an associated session, a time spent on a particular page, whether the particular page was refreshed, keys that were pressed, copy-paste actions that were taken, and mouse scrolls that occurred;
recording heartbeats at a threshold heartbeat interval indicating central processing unit (CPU) performance and whether the user was active;
recording page load events including identifying a time to process a page load request, a time to finish loading the page, a number of tabs that are open, and whether a page load was slow; and
recording document object model (DOM) including clicks by the user, scrolling by the user, an identifier of a software service, a class name and a subclass name of the software service, and content of text typed into the software service.

19. The computer-implemented system of claim 17, wherein tracking the sequence of events includes:
setting identifier threshold rules defining a set of identifiers used in set of systems that are to be tracked;
disregarding identifiers not included in a tracked subset of the multiple software services;
recording timestamps for start and end times on a particular software service; and
disregarding, using the start and end times, identifiers corresponding to events that last less than a threshold event duration.

20. The computer-implemented system of claim 17, wherein assigning each focus event of the focus events to a particular case includes linking previously unlinked identifiers from the software services by observing an expected behavioral pattern for using the multiple software services in a particular order pattern to respond to and close the particular case.
